(19) United States
(12) Patent Application Publication
(10) Pub. No.: US 2025/0209581 A1
(43) Pub. Date: Jun. 26, 2025

(54) IMAGE ENHANCEMENT WITH ADAPTIVE FEATURE SHARPENING FOR VIDEO SEE-THROUGH (VST) EXTENDED REALITY (XR) OR OTHER APPLICATIONS

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 18/787,406

(22) Filed: Jul. 29, 2024

Related U.S. Application Data
(60) Provisional application No. 63/614,857, filed on Dec. 26, 2023.

(51) Int. Cl. G06T 5/73; G06T 5/20; G06T 7/00

(52) U.S. Cl. CPC G06T 5/73; G06T 5/20; G06T 7/0002; G06T 2207/20004; G06T 2207/20092; G06T 2207/20224; G06T 2207/30168

(57) ABSTRACT

An electronic device includes at least one processing device configured to obtain an image. The at least one processing device is also configured to determine high-frequency features of the image using the image. The at least one processing device is further configured to determine a weighting map based on blurriness of at least some pixels in the image, where the weighting map represents how much to sharpen the at least some pixels in the image. The at least one processing device is also configured to apply the weighting map to the high-frequency features of the image to generate weighted high-frequency features. In addition, the at least one processing device is configured to combine the weighted high-frequency features with the at least some pixels in the image to generate an enhanced image.

### CROSS-REFERENCE TO RELATED APPLICATION AND PRIORITY CLAIM

This application claims priority under 35 U.S.C. § 119 (e) to U.S. Provisional Patent Application No. 63/614,857 filed on Dec. 26, 2023. This provisional patent application is hereby incorporated by reference in its entirety.

### TECHNICAL FIELD

This disclosure relates generally to image processing. More specifically, this disclosure relates to image enhancement with adaptive feature sharpening for video see-through (VST) extended reality (XR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to image enhancement with adaptive feature sharpening for video see-through (VST) extended reality (XR) or other applications.

In a first embodiment, a method includes obtaining, using at least one processing device of an electronic device, an image. The method also includes determining, using the at least one processing device, high-frequency features of the image using the image. The method further includes determining, using the at least one processing device, a weighting map based on blurriness of at least some pixels in the image, where the weighting map represents how much to sharpen the at least some pixels in the image. The method also includes applying, using the at least one processing device, the weighting map to the high-frequency features of the image to generate weighted high-frequency features. In addition, the method includes combining, using the at least one processing device, the weighted high-frequency features with the at least some pixels in the image to generate an enhanced image.

In a second embodiment, an electronic device includes at least one processing device configured to obtain an image. The at least one processing device is also configured to determine high-frequency features of the image using the image. The at least one processing device is further configured to determine a weighting map based on blurriness of at least some pixels in the image, where the weighting map represents how much to sharpen the at least some pixels in the image. The at least one processing device is also configured to apply the weighting map to the high-frequency features of the image to generate weighted high-frequency features. In addition, the at least one processing device is configured to combine the weighted high-frequency features with the at least some pixels in the image to generate an enhanced image.

In a third embodiment, a non-transitory machine readable medium contains instructions that when executed cause at least one processor of an electronic device to obtain an image. The non-transitory machine readable medium also contains instructions that when executed cause the at least one processor to determine high-frequency features of the image using the image. The non-transitory machine readable medium further contains instructions that when executed cause the at least one processor to determine a weighting map based on blurriness of at least some pixels in the image, where the weighting map represents how much to sharpen the at least some pixels in the image. The non-transitory machine readable medium also contains instructions that when executed cause the at least one processor to apply the weighting map to the high-frequency features of the image to generate weighted high-frequency features. In addition, the non-transitory machine readable medium contains instructions that when executed cause the at least one processor to combine the weighted high-frequency features with the at least some pixels in the image to generate an enhanced image.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2 and 3 illustrate an example process supporting adaptive feature sharpening for video see-through (VST) extended reality (XR) or other applications in accordance with this disclosure;

FIG. 4 illustrates a first example pipeline supporting adaptive feature sharpening for VST XR or other applications in accordance with this disclosure;

FIGS. 5A through 5C illustrate example operation of a pipeline supporting adaptive feature sharpening for VST XR or other applications in accordance with this disclosure;

FIGS. 6A and 6B illustrate a second example pipeline supporting adaptive feature sharpening for VST XR or other applications in accordance with this disclosure; and

FIG. 7 illustrates an example method for adaptive feature sharpening for VST XR or other applications in accordance with this disclosure.

### DETAILED DESCRIPTION

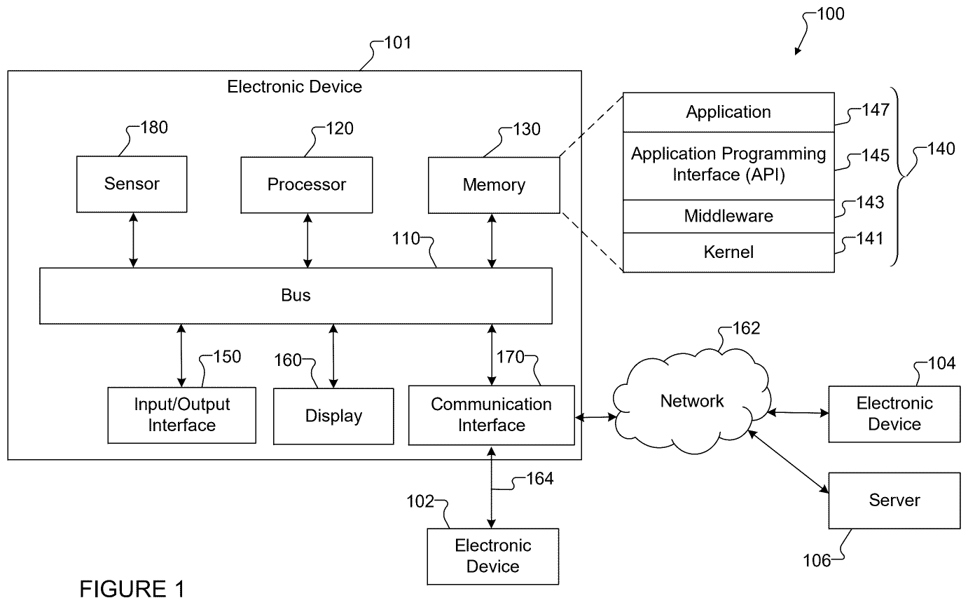

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video sec-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Unfortunately, VST XR devices can suffer from various shortcomings. For example, in VST XR pipelines, final views are often generated by transforming images captured using see-through cameras, and the final views are presented to users of the VST XR devices. The quality of the see-through images tends to be very important to the quality of the generated final views. Thus, for instance, noise in the captured see-through images can negatively affect user experiences and even functionalities of the VST XR devices. As particular examples, camera noise and blur can result in images with low visual qualities. Image transformations in a VST pipeline can also create blur or other issues in the final views.

This disclosure provides various techniques supporting adaptive feature sharpening for VST XR or other applications. As described in more detail below, an image can be obtained, such as from a see-through camera of a VST XR device, and high-frequency features of the image can be determined using the image. A weighting map based on blurriness of at least some pixels in the image can be determined, and the weighting map can represent how much to sharpen the at least some pixels in the image. The weighting map can be applied to the high-frequency features of the image to generate weighted high-frequency features, and the weighted high-frequency features can be combined with the at least some pixels in the image to generate an enhanced image. In some embodiments, the weighted high-frequency features may be combined with some but not all of the pixels in the image in order to provide image enhancement in a portion of the image without providing image enhancement in another portion of the image, such as when the portion of the image in which the image enhancement is provided represents a region of the image on which a user is focused. The enhanced image can be used in any suitable manner, such as when rendered and displayed to a user. This can be repeated for any number of images, such as for sequences of images obtained using left and right see-through cameras of a VST XR device.

In this way, these techniques can be used to provide a combination of denoising and feature sharpening that produces enhanced images of higher visual quality, which can significantly improve user experiences and enable more effective operation of VST XR or other image processing pipelines. As a particular example, in some cases, these techniques can be used to help make text captured in images to be more readable in enhanced images, which can be useful in VST XR applications or other applications where the enhanced images are displayed to users. Moreover, in some embodiments, these techniques can support the use of foveation rendering, where a region on which a user is focused is rendered at higher resolution and other non-focus areas are rendered at lower resolution. This can help to reduce computational loads in VST XR devices or other devices. In addition, these techniques can support adaptive feature sharpening in which image features are sharpened adaptively based on the blurriness of the image being processed, which can help to sharpen image features without sharpening noises.

Note that while the techniques for image enhancement based on adaptive feature sharpening are often described below as being used in VST XR applications, these techniques may be used in any other suitable applications. For example, these techniques may be used in various applications in which images are obtained from imaging sensors and in which the images may benefit from denoising, deblurring, or both. As particular examples, the described techniques may be used in various computer vision applications, such as to pre-process captured images in order to support object detection or object recognition operations involving the enhanced images. Enhanced images generated using the described image enhancement techniques may be stored, output, or used in any suitable manner depending on the application in which the image enhancement techniques are used.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to image enhancement with adaptive feature sharpening for VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform image enhancement with adaptive feature sharpening for VST XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to image enhancement with adaptive feature sharpening for VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

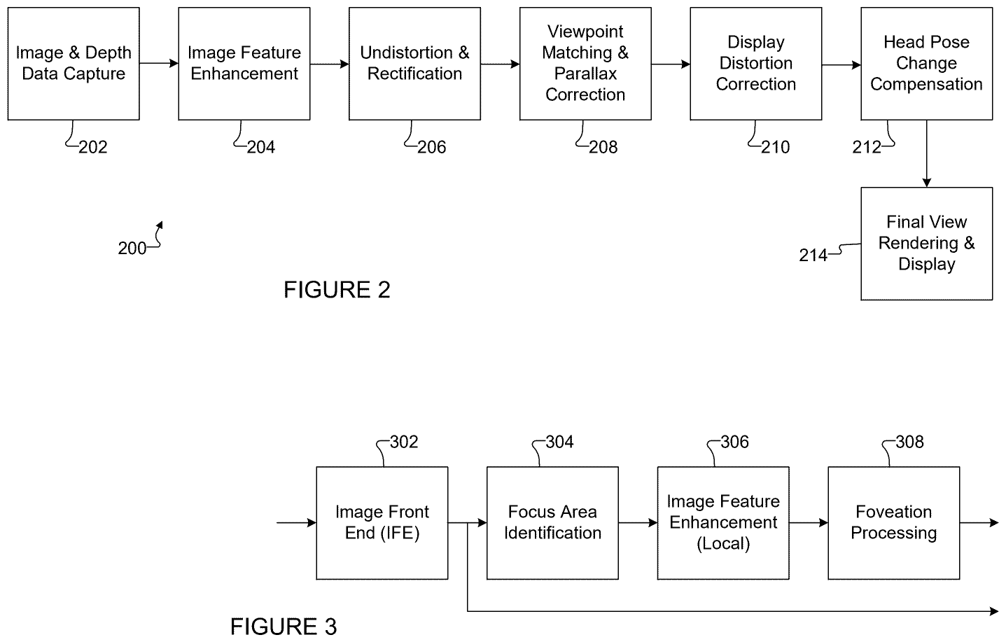

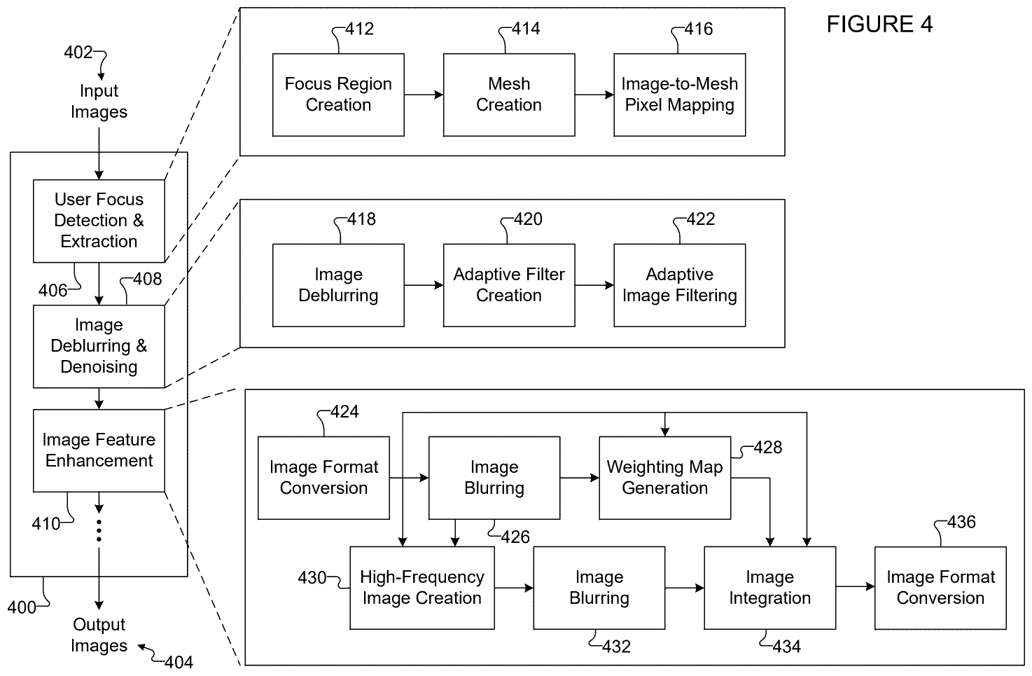

FIGS. 2 and 3 illustrate an example process 200 supporting adaptive feature sharpening for VST XR or other applications in accordance with this disclosure. For case of explanation, the process 200 of FIGS. 2 and 3 is described as being performed using the electronic device 101 in the network configuration 100 of FIG. 1. However, the process 200 may be performed using any other suitable device(s) and in any other suitable system(s).

As shown in FIG. 2, the process 200 includes an image and depth data capture operation 202, which generally operates to capture input images and (optionally) depth data associated with the input images for processing. For example, the image and depth data capture operation 202 may obtain input images captured using one or more see-through cameras or other imaging sensors 180 of a VST XR device or other electronic device 101. The image and depth data capture operation 202 may also optionally obtain depth maps or other depth data associated with the captured input images. In some embodiments, the depth maps or other depth data may be obtained using a depth sensor or other sensor(s) 180 of the VST XR device or other electronic device 101.

The input images and the optional depth data are provided to an image enhancement operation 204, which generally operates to enhance the input images and reduce noise, blurring, or other undesirable issues within the input images. As described below, the image enhancement operation 204 can be used to perform adaptive feature sharpening. For example, the image enhancement operation 204 may be used to perform image feature and text enhancement, where features and text within the input images are enhanced in order to improve the overall quality of the images. The image enhancement operation 204 can also perform image deblurring, image denoising, or both in order to at least partially remove blur, noise, or both from the input images. As described in more detail below, the image enhancement operation 204 may determine high-frequency features of the input image using the image and determine a weighting map based on blurriness of pixels in the input image. The image enhancement operation 204 may also apply the weighting map to the high-frequency features of the input image in order to generate weighted high-frequency features and combine the weighted high-frequency features with pixels in the input image in order to generate an enhanced image.

In some cases, the image enhancement operation 204 can provide image enhancement to the entirety of each input image. In other cases, the image enhancement operation 204 can provide image enhancement to a portion of each input image. As a particular example, the image enhancement operation 204 could provide image enhancement only to the portion of each input image where a user is directing his or her focus, which can support foveation rendering. In whatever manner implemented, the image enhancement operation 204 is able to provide image enhancement to at least part of each input image being processed.

The enhanced images can be subsequently processed using one or more image processing operations, which can vary depending on the implementation. In this example, the enhanced images are provided to an undistortion and rectification operation 206, which generally operates to undistort and rectify the enhanced images. With respect to undistortion, a see-through camera or other imaging sensor 180 typically includes at least one lens, and the at least one lens can create radial, tangential, or other type(s) of distortion(s) in captured images. The undistortion and rectification operation 206 may make adjustments to each enhanced image so that the resulting images substantially correct for the radial, tangential, or other type(s) of distortion(s). Among other things, the undistortion and rectification operation 206 can remove distortions and obtain regular-shaped images. In some cases, the undistortion and rectification operation 206 may include or have access to a camera matrix and a lens distortion model, which can be used to identify how each enhanced image should be adjusted so that the resulting image substantially corrects for the camera lens distortion(s). A camera matrix is often defined as a three-by-three matrix that includes two focal lengths in the x and y directions and the principal point of the camera defined using x and y coordinates. A lens distortion model is often defined as a mathematical model that indicates how images can be undistorted, which can be derived based on the specific lens or other optical component(s) being used.

With respect to rectification, multiple enhanced images may be aligned or rectified to support other functions in an image processing pipeline. For example, stereo pairs of enhanced images may be used to generate depth values associated with a scene. As a particular example, depth reconstruction may derive depth values in a scene based on stereo pairs of enhanced images of the scene, where disparities in locations of common points in the stereo images are used to estimate depths. In some cases, these depths may be combined with depth maps or other depths determined using one or more depth sensors 180, which is often referred to as “densification.” Multiple enhanced images from the same imaging sensor 180 or different imaging sensors 180 may be rectified to support other image processing functions.

A viewpoint matching and parallax correction operation 208 generally operates to modify images in order to provide appropriate viewpoints in the images and to provide appropriate parallax in the images. With respect to viewpoint matching, a VST XR device often includes one or more see-through cameras or other imaging sensors 180, and the VST XR device operates to present images to a user's eyes. The imaging sensors 180 are located in positions other than the positions of the user's eyes, which leads to different viewpoints of a scene between the imaging sensors 180 and the user's eyes. The viewpoint matching and parallax correction operation 208 can make adjustments to images so that the resulting images compensate for these different viewpoints. Thus, for instance, the viewpoint matching and parallax correction operation 208 may determine translations and rotations needed to convert the viewpoints of the imaging sensors 180 to the viewpoints of the user's eyes, and the viewpoint matching and parallax correction operation 208 can adjust images using the identified translations and rotations. These adjustments can be derived, for instance, based on known geometries of the VST XR device.

With respect to parallax correction, parallax refers to the difference in apparent positions of common points when viewed along different lines of sight. In a VST XR device, because the imaging sensors 180 are located at different positions than the user's eyes, the parallax at left and right imaging sensors 180 may be different than the parallax at left and right eyes of the user. The viewpoint matching and parallax correction operation 208 can make adjustments to images so that the resulting images compensate for this difference in parallax. Thus, for instance, the viewpoint matching and parallax correction operation 208 may determine how object points or other points within a captured scene would differ between image planes associated with the imaging sensors 180 and image planes associated with the user's eyes, and the viewpoint matching and parallax correction operation 208 can adjust images to implement these adjustments. Again, these adjustments can be derived, for instance, based on the known geometries of the VST XR device.

A display distortion correction operation 210 generally operates to modify images in order to correct for distortions caused by one or more displays. For example, in a VST XR device, rendered images presented on one or more displays 160 are often viewed by a user through left and right display lenses positioned between the user's eyes and the display(s) 160. However, the display lenses may create geometric distortions when displayed images are viewed, and the display lenses may create chromatic aberrations when light passes through the display lenses. The display distortion correction operation 210 can make adjustments to images so that the resulting images compensate for the geometric distortions and the chromatic aberrations. Thus, for instance, the display distortion correction operation 210 may determine how images should be pre-distorted to compensate for the subsequent geometric distortions and chromatic aberrations created when the images are displayed and viewed through the display lenses. In some cases, the display distortion correction operation 210 may operate based on a display lens geometric distortion correction (GDC) and chromatic aberration correction (CAC) model, which can mathematically represent the geometric distortions and chromatic aberrations created by the display lenses.

A head pose change compensation operation 212 generally operates to modify images in order to compensate for head pose changes of a user. For example, there is typically a delay between capture of images and display of corresponding rendered images in a VST XR device, and it is possible for the user to move his or her head during that intervening time period. The head pose change compensation operation 212 can use information (such as from an IMU, tracking camera, or other data) to predict how the user's head pose is expected to change between capture of images and display of corresponding rendered images. The head pose change compensation operation 212 can also apply a suitable transformation to each image, such as by rotating and/or translating each image, so that the transformed images are suitable for presentation at the user's predicted head pose.

A final view rendering and display operation 214 generally operates to process images and perform any additional refinements or modifications as needed or desired. The resulting images can represent the final views of a scene, and the final view rendering and display operation 214 can present rendered images of the final views to the user. For example, a 3D-to-2D warping can be used to warp the final views of the scene into 2D images. The final view rendering and display operation 214 can also render the images into a form suitable for transmission to at least one display 160 and can initiate display of the rendered images, such as by providing the rendered images to one or more displays 160.

As noted above, in some cases, foveation rendering may be supported in a VST XR device or other electronic device 101. One example of how the image enhancement operation 204 may be used to support foveation rendering within the process 200 is shown in FIG. 3. As shown in FIG. 3, an image front end (IFE) 302 may receive and process input images, such as input images provided by the image and depth data capture operation 202. The image front end 302 may perform any suitable function or functions to prepare the input images for additional processing, such as by performing any Bayer or other raw image pre-processing.

The input images provided by the image front end 302 are provided to a focus area identification operation 304, which generally operates to estimate where a user's eyes are focusing within the input images. The user's current area of focus, which is also called the user's region of interest, can be identified in any suitable manner, such as by using one or more eye tracking cameras or other sensors 180. The user's current area of focus may be on a particular object within the input images or on other contents within the input images. Note, however, that there may also be times when the user is not focusing on any specific portion of the input images.

If the user is focusing on specific portions of the input images, the input images (and optionally the associated depth data) are provided to an image enhancement operation 306, which generally operates to enhance each portion of the input images on which the user is focused and to reduce noise, blurring, or other undesirable issues in those portions of the input images. As described below, the image enhancement operation 306 can be used to perform adaptive feature sharpening. For example, the image enhancement operation 306 may be used to perform image feature and text enhancement, where features and text within the regions of interest in the input images are enhanced in order to improve the overall quality of those portions of the images. As described in more detail below, the image enhancement operation 306 may determine high-frequency features of the input image using the image and determine a weighting map based on blurriness of pixels in the input image. The image enhancement operation 306 may also apply the weighting map to the high-frequency features of the input image in order to generate weighted high-frequency features and combine the weighted high-frequency features with pixels in the input image in order to generate an enhanced image. Because the image enhancement operation 306 here may operate on portions (rather than all) of the input images, the image enhancement operation 306 may be said to provide local image enhancement.

If the user is focusing on specific portions of the input images, a foveation processing operation 308 generally operates to process the region of interest for each enhanced image as provided by the image enhancement operation 306. For example, the foveation processing operation 308 may increase the resolution of the image data in the region of interest for each enhanced image, correct or adjust the colors in the region of interest for each enhanced image, further reduce noise or blur in the region of interest for each enhanced image, or perform other processing functions. Note that limiting this processing to the region of interest for each enhanced image can help to reduce the computational load on a VST XR device or other device. The processed regions of interest for the enhanced images and the original input images (as provided by the image front end 302) may be output for further processing. For instance, the processed region of interest for each enhanced image may be combined with other non-regions of interest in the associated input image in order to generate final views of a scene. If the user is not focusing on any particular region within the input images, the input images (as provided by the image front end 302) may be output without data from the foveation processing operation 308.

Although FIGS. 2 and 3 illustrate one example of a process 200 supporting adaptive feature sharpening for VST XR or other applications, various changes may be made to FIGS. 2 and 3. For example, various components or operations in FIGS. 2 and 3 may be combined, further subdivided, replicated, omitted, or rearranged and additional components or operations may be added according to particular needs. Also, the process 200 shown in FIGS. 2 and 3 includes functions that may be useful in VST XR applications or other mobile applications, such as head change pose compensation. However, the techniques for image enhancement with adaptive feature sharpening described in this disclosure may be used in any other suitable processes, including those processes that do not support or include viewpoint matching, parallax correction, display distortion correction, head change pose compensation, foveation rendering, or any combination thereof.

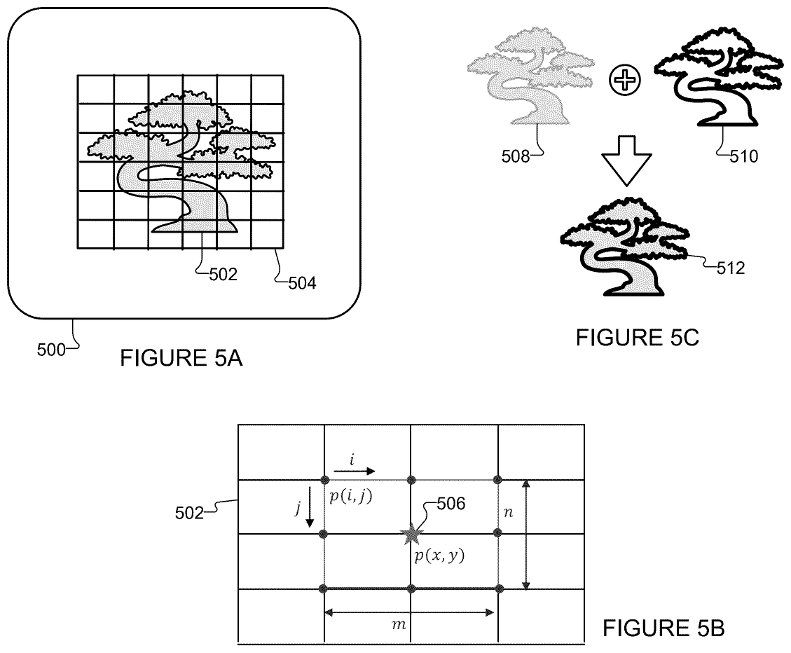

FIG. 4 illustrates a first example pipeline 400 supporting adaptive feature sharpening for VST XR or other applications in accordance with this disclosure. For ease of explanation, the pipeline 400 of FIG. 4 is described as being implemented using the electronic device 101 in the network configuration 100 of FIG. 1, which may be used to perform the process of FIGS. 2 and 3. However, the pipeline 400 may be implemented using any other suitable device(s) and in any other suitable system(s), and the pipeline 400 may be used to perform any other suitable process(es) (including processes without foveation rendering).

As shown in FIG. 4, the pipeline 400 is used to receive input images 402 and generate output images 404. The input images 402 may, for example, represent images obtained from one or more see-through cameras or other imaging sensors 180. In some cases, the input images 402 may be provided by the image and depth data capture operation 202 or the image front end 302. The output images 404 represent images that may be presented to a user of a VST XR device or other device, stored, or used in any other suitable manner.

In this example, the pipeline 400 includes multiple functions, including a user focus detection and extraction function 406, an image deblurring and denoising function 408, and an image feature enhancement function 410. As shown here, the user focus detection and extraction function 406 includes a focus region creation function 412, a mesh creation function 414, and an image-to-mesh mapping function 416. The focus region creation function 412 generally operates to determine if a user is focusing on a specific region of interest within each input image 402 and, if so, to identify the area of each input image 402 on which the user is focused. In some cases, the focus region creation function 412 may use data from one or more eye tracking cameras and/or perform gaze detection in order to estimate where it appears the user is focusing his or her attention within each input image 402. If the user is focused on a region of interest within an input image 402, the focus region creation function 412 can identify that region of interest. Each region of interest may be defined in any suitable manner, such as a rectangular, circular, or other region.

The mesh creation function 414 generally operates to define a mesh associated with each region of interest identified by the user focus detection and extraction function 406. A mesh is generally defined using a collection of lines that intersect at various points within the mesh. In some cases, a mesh can be planar and define the lines and intersection points within a two-dimensional (2D) plane. In other cases, a mesh can be based on depths within a scene and define the lines and intersection points within a three-dimensional (3D) space. The numbers of lines and intersection points within each mesh may vary depending on the circumstances, such as the size and shape of the region of interest identified by the user focus detection and extraction function 406. In some cases, each mesh can be created based on a designed or specified resolution to be provided in the associated region of interest. Note that if the pipeline 400 is used to process images from left and right see-through cameras or other collection of multiple imaging sensors 180 capturing the same scene, the mesh creation function 414 may identify one or more meshes for one or some images and translate, rotate, or otherwise modify the one or more meshes in order to generate one or more additional meshes for one or more other images. Also note that the meshes defined here may cover less than all of the corresponding images since they could relate to regions of the images on which the user is focused.

The image-to-mesh mapping function 416 generally operates to map the image data of each input image 402 onto the corresponding mesh identified by the mesh creation function 414 (if any). For example, the image-to-mesh mapping function 416 can identify which pixels within each input image 402 fall within the image's corresponding mesh and which of those pixels fall on the intersection points within the mesh. In some embodiments, this allows various functions (such as the image deblurring and denoising function 408 and the image feature enhancement function 410) to be performed using a GPU or other processing device separate from a CPU or other processing device that performs the user focus detection and extraction function 406.

The image deblurring and denoising function 408 can use the meshes provided by the user focus detection and extraction function 406 to perform deblurring and denoising in the regions of interest within the input images 402 (or to entire images if foveation rendering is not used). As shown here, the image deblurring and denoising function 408 includes an image deblurring function 418, an adaptive filter creation function 420, and an adaptive image filtering function 422. The image deblurring function 418 generally operates to reduce or remove blur contained in the input images 402 (if any). For example, the image deblurring function 418 may create or have access to a deblurring model, which can define how defocus and motion blur in the input images 402 can be corrected. The image deblurring function 418 can apply the deblurring model to the input images 402 in order to reduce or remove any blur contained in the input images 402.

The adaptive filter creation function 420 generally operates to generate adaptive filters, and the adaptive image filtering function 422 generally operates to apply each adaptive filter to one or more of the input images 402 in order to remove noise contained in the input images 402. In some embodiments, each adaptive filter that is created and used here can be feature-aware, meaning the adaptive filter is created and used while being guided by the features or other contents present in the associated input image(s) 402. This allows each adaptive filter to be used to smooth image data or otherwise filter noise from the image data without significantly smoothing actual features that should remain in the input images 402. As a result, pixels within the input images 402 can be updated to remove noise without unnecessarily affecting actual image features. One example technique for creating and using adaptive filters is provided below, although any other suitable techniques may be used here. This results in the generation of deblurred and denoised images, which contain less blurring/noise compared to the original input images 402.

The image feature enhancement function 410 can process the deblurred and denoised images in order to perform image enhancement. In this example, it is assumed that the image enhancement is performed only for the regions of interest on which the user is focused in the deblurred and denoised images. However, as noted above, image enhancement may be performed for the entirety of the images. Note that since the image deblurring and denoising function 408 has already removed noise from the images, the image feature enhancement function 410 can focus primarily on enhancing actual image features without significantly enhancing noise. As shown here, the image feature enhancement function 410 may include an image format conversion function 424, which generally operates to convert the deblurred and denoised images from one image format to another image format. For example, the image format conversion function 424 may convert the deblurred and denoised images from one color space to another color space, such as from the RGB space to the YUV space or the YCbCr space. This can help to separate images into luminance and chrominance components, which can be useful when image feature enhancement is performed using the luminance component only. The image format conversion function 424 may also convert integer pixel values into floating-type values. Note, however, that the image format conversion function 424 is optional and may not be needed if the deblurred and denoised images can be processed directly. Images generated by the image format conversion function 424 may be denoted I below.

The converted images are provided to an image blurring function 426, which generally operates to blur the images and generate blurred images. For example, the image blurring function 426 may apply a Gaussian blur to the converted images in order to generate the blurred images. As a particular example, the image blurring function 426 may convolve each converted image with a Gaussian kernel or other smoothing kernel in order to generate the corresponding blurred image. Blurred images generated by the image blurring function 426 may be denoted I_{b} below.

The converted images are also provided to a weighting map generation function 428, which generally operates to generate weighting maps associated with the converted images. As described below, the weighting maps can be used to control how much image sharpening is provided by the image feature enhancement function 410. For example, the weighting maps may be used to control how high-frequency features of the converted images are combined with the converted images during image enhancement. In some embodiments, each weighting map can identify an image enhancement weight for each pixel of the corresponding converted image.

The weighting map generation function 428 can use any suitable technique to generate weighting maps that identify where and to what extent image enhancement is performed. Moreover, the weighting map generation function 428 can adaptively generate the weighting maps so that the weighting maps are based on the features or other image contents in the associated converted images. For instance, in some embodiments, the weighting map generation function 428 can adaptively generate the weights in the weighting maps based on blurriness estimations, where each blurriness estimation estimates the amount of blur contained at a specified location (possibly at the pixel level) in a converted image. The weighting map generation function 428 can also use any suitable technique to generate the blurriness estimations themselves. For example, in some embodiments, each weight in a weighting map can correspond to a given pixel in a converted image and can be based on a difference between (i) a value of the given pixel and (ii) one or more values of one or more neighboring pixels around the given pixel. In other embodiments, each weight in a weighting map can correspond to a given pixel in a converted image and can be based on a difference between (i) a feature map of the given pixel and (ii) one or more feature maps of one or more neighboring pixels around the given pixel.

The converted images and the blurred images are provided to a high-frequency image creation function 430, which generally operates to generate images containing high-frequency features of the converted images or to otherwise extract high-frequency features of the converted images. For example, the high-frequency image creation function 430 may subtract each pixel value in a blurred image from a corresponding pixel value in the associated converted image, and this can be done on a pixel-by-pixel basis. Note, however, that other approaches may be used to generate high-frequency images or to otherwise extract the high-frequency features. For example, in other embodiments, the high-frequency image creation function 430 may determine a “difference of Gaussians” using a converted image. A difference of Gaussians can be determined by convolving each converted image using two different Gaussian kernels and determining a difference between the results of the convolutions (in which case the converted image need not be blurred using the image blurring function 426). High-frequency images generated by the high-frequency image creation function 430 may be denoted If below.

The extracted high-frequency features may be provided to an image blurring function 432, which generally operates to blur the high-frequency features and generate blurred high-frequency features. For example, the image blurring function 432 may apply a Gaussian blur to the high-frequency features in order to generate the blurred high-frequency features. As a particular example, the image blurring function 432 may convolve each high-frequency image with a Gaussian kernel or other smoothing kernel in order to generate the corresponding blurred high-frequency image. Blurred high-frequency images generated by the image blurring function 432 may be denoted I_{fb} below.

An image integration function 434 generally operates to combine the converted images with weighted versions of their corresponding blurred high-frequency features. For example, the image integration function 434 may multiply the pixel values of each blurred high-frequency image by the weights of the associated weighting map, and the image integration function 434 can add the weighted pixel values to the pixel values of the corresponding converted image. This leads to the generation of enhanced images in which the high-frequency features are clearer or more pronounced. Enhanced images generated by the image integration function 434 may be denoted I, below.

The enhanced images are provided to an image format conversion function 436, which generally operates to convert the enhanced images from one image format to another image format. For example, the image format conversion function 436 may convert the enhanced images from one color space to another color space, such as from the YUV space or the YCbCr space to the RGB space. The enhanced images can be further processed as needed or desired by one or more subsequent functions in the pipeline 400 in order to generate the output images 404. For instance, one or more subsequent functions in the pipeline 400 could include one or more functions implementing the undistortion and rectification operation 206, the viewpoint matching and parallax correction operation 208, the display distortion correction operation 210, the head pose change compensation operation 212, the final view rendering and display operation 214, or any combination thereof.

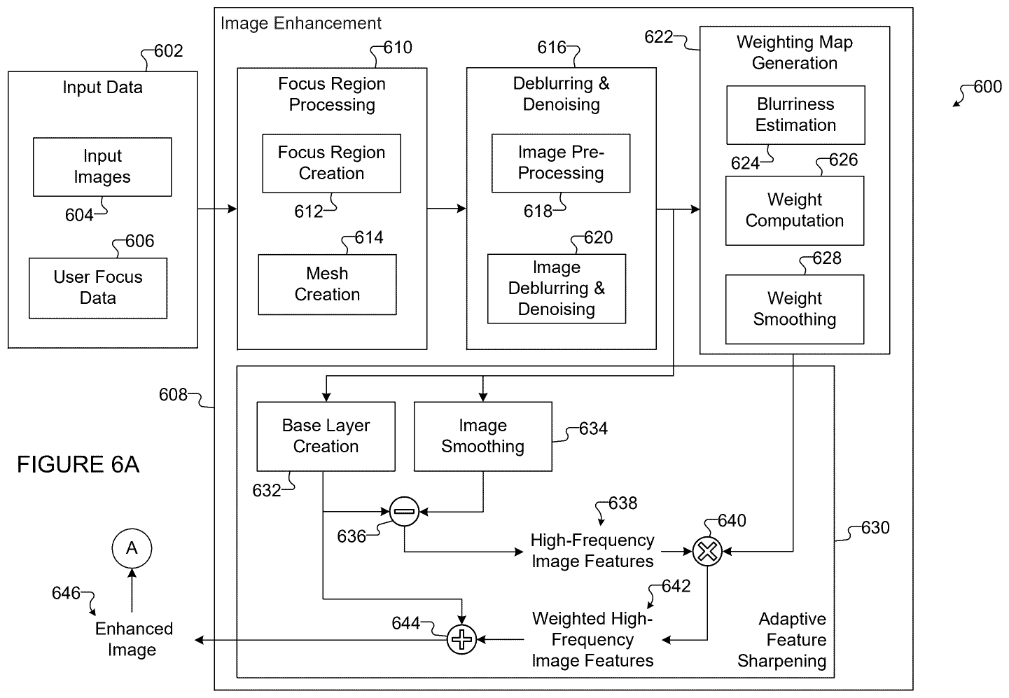

FIGS. 5A through 5C illustrate example operation of the pipeline 400 supporting adaptive feature sharpening for VST XR or other applications in accordance with this disclosure. As shown in FIG. 5A, an image 500 of a scene includes an object 502, which in this example represents a tree. A user may be focusing on the object 502, and the pipeline 400 can be used to identify a mesh 504 that encompasses the object 502.

As shown in FIG. 5B, the mesh 504 can be used (among other things) to define weights in a weighting map associated with the image 500. In some embodiments, each pixel 506 of the image 500 can have a corresponding weight in the image's associated weighting map. In this example, the weight for each pixel 506 of the image 500 can be based on the pixel values in a neighborhood around the pixel 506. The neighborhood can encompass any number of neighboring pixels. The weight for the pixel 506 here may be determined based on local blurriness of the image 500 around the pixel 506.

As shown in FIG. 5C, the pipeline 400 operates to generate weighted high-frequency features 510, which represent high-frequency features of the image 500 that are scaled (multiplied) by the weights in the weighting map associated with the image 500. The image data for the object 502 in the image 500 can be combined with the weighted high-frequency features 510, resulting in the generation of enhanced image data 512 associated with the object 502. The enhanced image data 512 can form part of an enhanced image generated by the pipeline 400.

The following now describes how certain operations within the pipeline 400 may be designed or performed. The image deblurring and denoising function 408 can create adaptive filters and apply each adaptive filter to one or more images to support denoising. In some cases, an adaptive filter can be determined as follows. A space weight wₛ(p) for each pixel in an image can be determined as follows.

$${w}_{s} ( p ) = {G}_{{σ}_{s}} ( ‖ p - q ‖ )$$

Here, q∈ [symbol] (p) represents a neighboring pixel of pixel p, and G_{σ}_{ₛ}(⋅) represents a Gaussian distribution. Similarly, a range weight wᵢ(p) for each pixel in an image can be determined as follows.

$${w}_{i} ( p ) = {G}_{{σ}_{i}} ( ‖ {I}_{p} - {I}_{q} ‖ )$$

Here, Iₚ and I_{q} respectively represent an intensity of pixel p and an intensity of pixel q, where q∈ [symbol] (p). Also, G_{σ}_{ᵢ}(⋅) represents a Gaussian distribution. In addition, a feature weight w_{f}(p) for each pixel in an image can be determined with feature information as follows.

$${w}_{f} ( p ) = {G}_{{σ}_{f}} ( ‖ {F}_{p} - {F}_{q} ‖ )$$

Here, Fₚ and F_{q} respectively represent a feature map of pixel p and a feature map of pixel q, where q∈ [symbol] (p). Also, G_{σ}_{_{f}}(⋅) represents a Gaussian distribution. Based on this, an adaptive filter may be defined based on the space weight, range weight, and feature weight. As a particular example, the adaptive filter may be defined to operate as follows.

$${I}_{{p}_{update}} = \frac{1}{{\sum }_{q ∈ ℕ ( p )} {w}_{s} ( p ) {w}_{i} ( p ) {w}_{f} ( p )} {\sum }_{q ∈ ℕ ( p )} {w}_{s} ( p ) {w}_{i} ( p ) {w}_{f} ( p ) {I}_{q}$$

Here, Iₚ_{_{update}} represents a denoised image after application of the adaptive filter to an image I_{q}. The adaptive filter can be used to update pixel values to remove noise without significantly smoothing image features.

The image feature enhancement function 410 can process deblurred and denoised images in order to enhance all or portions of the deblurred and denoised images. The image blurring function 426 may optionally be used to blur each of the deblurred and denoised images, such as by using a Gaussian kernel G(x, y), where (x, y) represents the coordinate of a pixel. In some cases, each deblurred and denoised image can be convolved with this Gaussian kernel G(x, y) to obtain a corresponding blurred image I_{b}, and a high-frequency image I_{f} can be generated for each deblurred and denoised image/blurred image pair. For example, a high-frequency image I_{f} can be generated by subtracting pixels values of a blurred image from the pixel values of a corresponding deblurred and denoised image, which can be expressed as follows.

$${I}_{f} = I - {I}_{b}$$

In other cases, a high-frequency image I_{f} can be generated without generating a blurred version of each deblurred and denoised image. For instance, a high-frequency image I_{f} can be generated by convolving a deblurred and denoised image with different Gaussian kernels and determining a difference between results of the convolutions (thereby supporting the “difference of Gaussians” approach). In some cases, this can be expressed as follows.

$${I}_{f b} = I * ( {G}_{{σ}_{1}} - {G}_{{σ}_{2}} )$$

Here, G_{σ}_{_{1 and G}}_{σ}_{₂} represent different Gaussian kernels, and σ₁ and σ₂ represent standard deviations of the different Gaussian kernels (where σ₁<σ₂). Each of the Gaussian kernels may be multiplied with a normalization constant. Each high-frequency image I_{f} can be blurred using the image blurring function 432 to generate a blurred high-frequency image I_{fb}.

The weighting map generation function 428 can generate weighting maps for the converted images based on one or more factors, such as blurriness estimations of the converted images. Each weighting map can adaptively identify how much sharpening to apply to individual pixels based on blurriness at the pixel-level. In some cases, a blurriness map can be generated for each converted image, where the blurriness map identifies blurriness estimates for the converted image.

As shown in FIG. 5B, for example, a weight for each pixel 506 may be generated using one or more values associated with one or more neighboring pixels. As a particular example, for each pixel p(x, y), a window with neighboring pixels may be defined as follows.

$$p ( i , j ) ∈ ( 0 \leq i < n , 0 \leq j < m )$$

Here, [symbol] (⋅) represents a collection of one or more neighboring pixels. A mean and a standard deviation (μ, σ) are calculated for the image data in the window. A blurriness map may be created using a standard deviation map containing standard deviations of the image data, such as in the following manner.

$$B ( x , y ) = σ ( x , y ) , ( 0 \leq x < M , 0 \leq y < N )$$

Here, (M, N) represents the size of the converted image being processed. A weighting map can be generated based on the blurriness map, such as in the following manner.

$$W ( x , y ) = {e}^{- f ( B ( x , y ) )}$$

Here, ƒ(⋅) is a function applied to the blurriness map, and the function ƒ(⋅) can be defined in any suitable manner based on the specific application.

Each blurred high-frequency image I_{fb} can be integrated with an original image I (a deblurred and denoised image) based on the associated weighting map to create an enhanced image Iᵣ. In some cases, this can be expressed as follows.

$${I}_{r} = I + {wI}_{f b}$$

Here, w represents weights from the weighting map that are used for sharpening image data based on the high-frequency features. The weights w may be contained in a matrix, and an element-wise multiplication can be performed between the weight matrix and the image data in the blurred high-frequency image I_{fb}. In some cases, each weight in the weighting map may be larger when associated with an actual image feature and lower when associated with a background.

Although FIG. 4 illustrates a first example of a pipeline 400 supporting adaptive feature sharpening for VST XR or other applications, various changes may be made to FIG. 4. For example, various components or functions in FIG. 4 may be combined, further subdivided, replicated, omitted, or rearranged and additional components or functions may be added according to particular needs. Although FIGS. 5A through 5C illustrate examples of operation of the pipeline 400 supporting adaptive feature sharpening for VST XR or other applications, various changes may be made to FIGS. 5A through 5C. For instance, the contents of an image being enhanced can vary widely based on the circumstances, and any other suitable technique may be used to generate a weighting map.

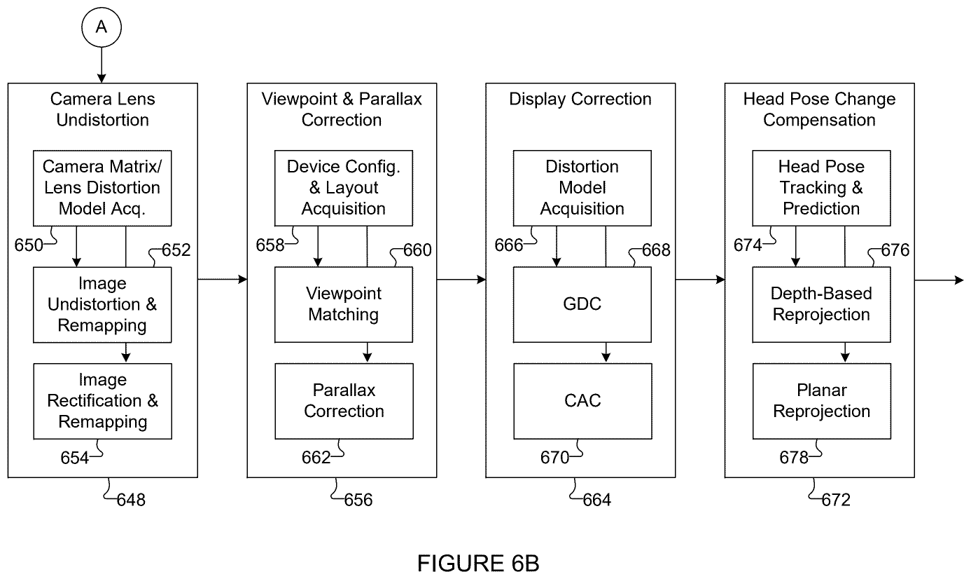

FIGS. 6A and 6B illustrate a second example pipeline 600 supporting adaptive feature sharpening for VST XR or other applications in accordance with this disclosure. For case of explanation, the pipeline 600 of FIGS. 6A and 6B is described as being implemented using the electronic device 101 in the network configuration 100 of FIG. 1, which may be used to perform the process of FIGS. 2 and 3. However, the pipeline 600 may be implemented using any other suitable device(s) and in any other suitable system(s), and the pipeline 600 may be used to perform any other suitable process(es) (including processes without foveation rendering).

As shown in FIG. 6A, the pipeline 600 receives and processes various input data 602, such as input images 604 and user focus data 606. For example, in some embodiments, the input images 604 may be obtained from one or more see-through cameras or other imaging sensors 180 of a VST XR device or other electronic device 101. Also, in some embodiments, the user focus data 606 may be obtained using one or more eye tracking cameras and/or performing gaze detection.

An image enhancement function 608 generally operates to perform feature enhancement in order to enhance the input images 604. In this example, the image enhancement function 608 includes a focus region processing function 610, which may be the same as or similar to the user focus detection and extraction function 406 described above. For example, the focus region processing function 610 can include a focus region creation function 612 and a mesh creation function 614, which may be the same as or similar to the focus region creation function 412 and the mesh creation function 414 described above. While not shown here, the focus region processing function 610 may also include the image-to-mesh mapping function 416.

The image enhancement function 608 also includes a deblurring and denoising function 616, which may be the same as or similar to the image deblurring and denoising function 408 described above. For example, the deblurring and denoising function 616 can include an image pre-processing function 618 and an image deblurring and denoising function 620. The image pre-processing function 618 may be used to provide any desired pre-processing of the input images 604, such as to convert the color space, format, and/or type of the input images 604. The image deblurring and denoising function 620 can filter the converted images, such as by using adaptive filtering as described above.

Deblurred and denoised images are provided to a weighting map generation function 622, which may be the same as or similar to the weighting map generation function 428 described above. In this example, the weighting map generation function 622 includes a blurriness estimation function 624, a weight computation function 626, and a weight smoothing function 628. The blurriness estimation function 624 generally operates to estimate blurriness within each deblurred and denoised image, such as by determining a weight for each specified pixel of a deblurred and denoised image using one or more pixels within a neighborhood around the specified pixel. The weight computation function 626 generally operates to generate weights based on the blurriness estimates. In some embodiments, these functions may be performed using the equations associated with the weighting map generation function 428 described above. The weight smoothing function 628 generally operates to filter or smooth the determined weights, such as to reduce or avoid large sudden changes in the weights within a weighting map.

The deblurred and denoised images and the weighting maps are provided to an adaptive feature sharpening function 630, which applies the weighting maps to the deblurred and denoised images in order to provide image enhancement. In this example, the adaptive feature sharpening function 630 includes a base layer creation function 632, which generally operates to create a base layer for each deblurred and denoised image to be used in subsequent processing functions. The base layer may represent the deblurred and denoised image or an image that is based on the deblurred and denoised image. An image smoothing function 634 generally operates to smooth or otherwise blur each deblurred and denoised image and may be the same as or similar to the image blurring function 426 described above.

A difference function 636 subtracts the pixel values generated by the image smoothing function 634 from the pixel values generated by the base layer creation function 632 for each deblurred and denoised image, which leads to the generation of high-frequency image features 638 for each deblurred and denoised image. A scaling function 640 multiplies the high-frequency image features 638 by the weights determined using the weighting map generation function 622 for each deblurred and denoised image, which leads to the generation of adaptive or weighted high-frequency image features 642 for each deblurred and denoised image. A combiner function 644 combines the image data of the base layer for each deblurred and denoised image with the associated weighted high-frequency image features 642 for that deblurred and denoised image in order to generate an enhanced image 646.

As shown in FIG. 6B, each enhanced image 646 is provided to a camera lens undistortion function 648, which may implement the undistortion and rectification operation 206 described above. For example, the camera lens undistortion function 648 can include a camera matrix and lens distortion model acquisition function 650, which can obtain a camera matrix and a lens distortion model (such as from a memory 130). An image undistortion and remapping function 652 may generally operate to perform undistortion in order to reduce or minimize radial, tangential, or other type(s) of distortion(s) in the enhanced images 646 caused by one or more lenses in one or more cameras or other imaging sensors 180 used to capture the original input images 604 as described above. An image rectification and remapping function 654 may generally operate to perform rectification in order to align the enhanced images 646 as described above.

A viewpoint and parallax correction function 656 may implement the viewpoint matching and parallax correction operation 208 described above. For example, the viewpoint and parallax correction function 656 can include a device configuration and layout acquisition function 658, which can obtain various information related to the configuration and layout of a VST XR device or other electronic device 101 (such as from a memory 130). The configuration and layout information may include, for instance, the locations of see-through cameras or other imaging sensors 180, display panels or other display(s) 160, and the expected locations of a user's eyes when viewing the display(s) 160. A viewpoint matching function 660 may generally operate to determine translations and rotations needed to convert the viewpoints of the imaging sensors 180 to the viewpoints of the user's eyes and to adjust images using the identified translations and rotations as described above. A parallax correction function 662 may generally operate to determine how points within a captured scene would differ between image planes associated with the imaging sensors 180 and image planes associated with the user's eyes and to adjust images to implement these adjustments as described above.

A display correction function 664 may implement the display distortion correction operation 210 described above. For example, the display correction function 664 may include a distortion model acquisition function 666, which can be used to obtain a display lens GDC and CAC model that represents geometric distortions and chromatic aberrations created by display lenses. A geometric distortion correction function 668 can modify enhanced images in order to compensate for geometric distortions created by the display lenses as described above. A chromatic aberration correction function 670 can modify enhanced images in order to compensate for chromatic aberrations created by the display lenses as described above.

A head pose change compensation function 672 may implement the head pose change compensation operation 212 described above. For example, the head pose change compensation function 672 may include a head pose tracking and prediction function 674, which can be used to track and predict the head pose of a user over time and to reconstruct depths within a scene based on the predicted head pose of the user. In some embodiments, the head pose tracking and prediction function 674 may use a head pose model that can estimate the future head pose of a user given current and previous head poses or head pose changes associated with the user. Depending on how the user's head pose is expected to change or the configuration of the VST XR device or other electronic device 101, a depth-based reprojection function 676 or a planar reprojection function 678 may be used to reproject the enhanced images 646 to compensate for the user's head pose changes. The depth-based reprojection function 676 can reconstruct depths within a scene given the user's expected head pose and use those depths to reproject the enhanced images 646. The planar reprojection function 678 may reproject the enhanced images 646 to a single plane or to multiple planes within a scene, where each plane has a known depth within the scene. Planar reprojection tends to be computationally simpler to perform, while depth-based reprojection tends to provide more accurate results.

Although FIGS. 6A and 6B illustrate a second example of a pipeline 600 supporting adaptive feature sharpening for VST XR or other applications, various changes may be made to FIGS. 6A and 6B. For example, various components or functions in FIGS. 6A and 6B may be combined, further subdivided, replicated, omitted, or rearranged and additional components or functions may be added according to particular needs.

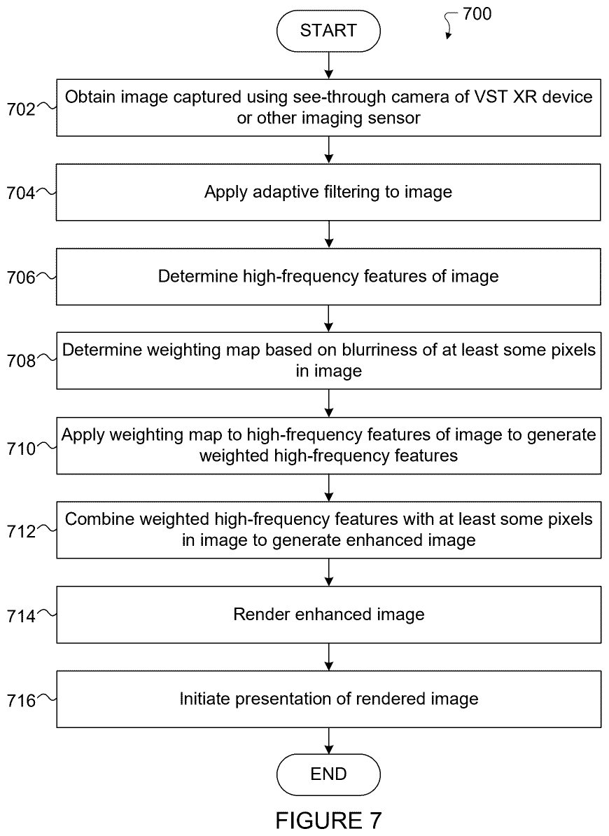

FIG. 7 illustrates an example method 700 for adaptive feature sharpening for VST XR or other applications in accordance with this disclosure. For ease of explanation, the method 700 of FIG. 7 is described as being performed using the electronic device 101 in the network configuration 100 of FIG. 1, where the electronic device 101 can implement the pipeline 400 of FIG. 4 or the pipeline 600 of FIGS. 6A and 6B and perform the process of FIGS. 2 and 3. However, the method 700 may be performed using any other suitable device(s) and pipeline(s) and in any other suitable system(s), and the method 700 may be used to form any other suitable process.

As shown in FIG. 7, an image captured using a see-through camera of a VST XR device or other imaging sensor is obtained at step 702. This could include, for example, the processor 120 of the electronic device 101 obtaining an input image 402, 604 captured using a see-through camera or other imaging sensor 180 of a VST XR device or other electronic device 101.

Adaptive filtering may be applied to the image at step 704. This could include, for example, the processor 120 of the electronic device 101 performing the image deblurring and denoising function 408 or the image deblurring and denoising function 620 to generate an adaptive filter and apply the adaptive filter to the image. In some embodiments, the adaptive filter is based on a space weight, a range weight, and a feature weight as described above. As a particular example, the adaptive filtering for a given pixel in the input image 402, 604 may be based on (i) a difference between a value of the given pixel and one or more values of one or more neighboring pixels around the given pixel or (ii) a difference between a feature map of the given pixel and one or more feature maps of the one or more neighboring pixels around the given pixel.

High-frequency features of the image are determined at step 706. This could include, for example, the processor 120 of the electronic device 101 performing the image feature enhancement function 410 or the image enhancement function 608 to identify the high-frequency image features of the filtered input image 402, 604. As a particular example, the processor 120 of the electronic device 101 could generate a blurred version of the filtered input image 402, 604 and subtract pixel values of the blurred version of the filtered input image 402, 604 from pixel values of the filtered input image 402, 604. As another particular example, the processor 120 of the electronic device 101 could convolve the filtered input image 402, 604 with different Gaussian kernels and determine a difference between the resulting convolutions in order to support a difference of Gaussians approach.

A weighting map is determined based on blurriness of at least some of the pixels of the image at step 708. This could include, for example, the processor 120 of the electronic device 101 performing the image feature enhancement function 410 or the image enhancement function 608 to identify a blurriness map or other blurriness estimates for the pixels of the filtered input image 402, 604 and generating weights of a weighting map based on the blurriness estimates. This could be done for all pixels within the filtered input image 402, 604 or for a subset of the pixels within the filtered input image 402, 604, such as only for the pixels within a region of interest on which a user is focused.

The weighting map is applied to the high-frequency features of the image in order to generate weighted high-frequency features at step 710. This could include, for example, the processor 120 of the electronic device 101 performing the image feature enhancement function 410 or the image enhancement function 608 to multiply the pixel values of the identified high-frequency image features with the corresponding weights of the weighting map. The weighted high-frequency features are combined with at least some of the pixels of the image to generate an enhanced image at step 712. This could include, for example, the processor 120 of the electronic device 101 performing the image feature enhancement function 410 or the image enhancement function 608 to combine the pixels values of the weighted high-frequency features with at least some of the pixel values of the filtered input image 402, 604.

The resulting enhanced image may be stored, output, or used in any suitable manner. For instance, the enhanced image may be rendered at step 714, and presentation of the rendered image may be initiated at step 716. This could include, for example, the processor 120 of the electronic device 101 rendering the enhanced image into a form suitable for display and communicating the resulting image data to the display(s) 160 of the electronic device 101 for presentation.

Although FIG. 7 illustrates one example of a method 700 for adaptive feature sharpening for VST XR or other applications, various changes may be made to FIG. 7. For example, while shown as a series of steps, various steps in FIG. 7 may overlap, occur in parallel, occur in a different order, or occur any number of times (including zero times). Also, various steps in FIG. 7 may be repeated in order to process any suitable number of images from any suitable number of imaging sensors, such as to process a sequence of images from left and right see-through cameras or other collections of imaging sensors.

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an image;
determining, using the at least one processing device, high-frequency features of the image using the image;
determining, using the at least one processing device, a weighting map based on blurriness of at least some pixels in the image, the weighting map representing how much to sharpen the at least some pixels in the image;
applying, using the at least one processing device, the weighting map to the high-frequency features of the image to generate weighted high-frequency features; and
combining, using the at least one processing device, the weighted high-frequency features with the at least some pixels in the image to generate an enhanced image.

2. The method of claim 1, wherein the weighted high-frequency features are combined with some but not all of the pixels in the image in order to provide image enhancement in a portion of the image without providing image enhancement in another portion of the image.

3. The method of claim 2, wherein the portion of the image in which the image enhancement is provided represents a region of the image on which a user is focused.

4. The method of claim 2, further comprising:
identifying a region of the image on which a user is focused;
creating a mesh associated with the identified region; and
mapping the pixels in the image within the region onto the mesh;
wherein combining the weighted high-frequency features with the at least some pixels comprises combining the weighted high-frequency features with the mapped pixels.

5. The method of claim 1, further comprising:
adaptively filtering the image prior to determining the high-frequency features of the image and prior to determining the weighting map;
wherein the adaptive filtering for a given pixel in the image is based on a difference between (i) a value of the given pixel and (ii) one or more values of one or more neighboring pixels around the given pixel.

6. The method of claim 1, wherein:
adaptively filtering the image prior to determining the high-frequency features of the image and prior to determining the weighting map;
wherein the adaptive filtering for a given pixel in the image is based on a difference between (i) a feature map of the given pixel and (ii) one or more feature maps of one or more neighboring pixels around the given pixel.

7. The method of claim 1, wherein determining the high-frequency features of the image comprises one of:
generating a blurred version of the image and subtracting the blurred version of the image from the image; or
convolving the image with different Gaussian kernels and determining a difference between resulting convolutions.

8. The method of claim 1, wherein:
the image is obtained using a see-through camera of a video see-through (VST) extended reality (XR) device; and
the method further comprises presenting the enhanced image on a display of the VST XR device.

9. An electronic device comprising:
at least one processing device configured to:
obtain an image;
determine high-frequency features of the image using the image;
determine a weighting map based on blurriness of at least some pixels in the image, the weighting map representing how much to sharpen the at least some pixels in the image;
apply the weighting map to the high-frequency features of the image to generate weighted high-frequency features; and
combine the weighted high-frequency features with the at least some pixels in the image to generate an enhanced image.

10. The electronic device of claim 9, wherein the at least one processing device is configured to combine the weighted high-frequency features with some but not all of the pixels in the image in order to provide image enhancement in a portion of the image without providing image enhancement in another portion of the image.

11. The electronic device of claim 10, wherein the portion of the image in which the image enhancement is provided represents a region of the image on which a user is focused.

12. The electronic device of claim 10, wherein the at least one processing device is further configured to:
identify a region of the image on which a user is focused;
create a mesh associated with the identified region; and
map the pixels in the image within the region onto the mesh; and
wherein, to combine the weighted high-frequency features with the at least some pixels, the at least one processing device is configured to combine the weighted high-frequency features with the mapped pixels.

13. The electronic device of claim 9, wherein:
the at least one processing device is further configured to adaptively filter the image prior to determining the high-frequency features of the image and prior to determining the weighting map;
wherein the adaptive filtering for a given pixel in the image is based on a difference between (i) a value of the given pixel and (ii) one or more values of one or more neighboring pixels around the given pixel.

14. The electronic device of claim 9, wherein:
the at least one processing device is further configured to adaptively filter the image prior to determining the high-frequency features of the image and prior to determining the weighting map;
wherein the adaptive filtering for a given pixel in the image is based on a difference between (i) a feature map of the given pixel and (ii) one or more feature maps of one or more neighboring pixels around the given pixel.

15. The electronic device of claim 9, wherein, to determine the high-frequency features of the image, the at least one processing device is configured to one of:
generate a blurred version of the image and subtract the blurred version of the image from the image; or
convolve the image with different Gaussian kernels and determine a difference between resulting convolutions.

16. A non-transitory machine readable medium containing instructions that when executed cause at least one processor of an electronic device to:
obtain an image;
determine high-frequency features of the image using the image;
determine a weighting map based on blurriness of at least some pixels in the image, the weighting map representing how much to sharpen the at least some pixels in the image;
apply the weighting map to the high-frequency features of the image to generate weighted high-frequency features; and
combine the weighted high-frequency features with the at least some pixels in the image to generate an enhanced image.

17. The non-transitory machine readable medium of claim 16, wherein the instructions when executed cause the at least one processor to combine the weighted high-frequency features with some but not all of the pixels in the image in order to provide image enhancement in a portion of the image without providing image enhancement in another portion of the image.

18. The non-transitory machine readable medium of claim 17, further containing instructions that when executed cause the at least one processor to:
identify a region of the image on which a user is focused;
create a mesh associated with the identified region; and
map the pixels in the image within the region onto the mesh; and
wherein the instructions that when executed cause the at least one processor to combine the weighted high-frequency features with the at least some pixels comprise:
instructions that when executed cause the at least one processor to combine the weighted high-frequency features with the mapped pixels.

19. The non-transitory machine readable medium of claim 16, further containing instructions that when executed cause the at least one processor to adaptively filter the image prior to determining the high-frequency features of the image and prior to determining the weighting map;
wherein the adaptive filtering for a given pixel in the image is based on a difference between:
a difference between (i) a value of the given pixel and (ii) one or more values of one or more neighboring pixels around the given pixel; or
a difference between (i) a feature map of the given pixel and (ii) one or more feature maps of the one or more neighboring pixels around the given pixel.

20. The non-transitory machine readable medium of claim 16, wherein the instructions that when executed cause the at least one processor to determine the high-frequency features of the image comprise:
instructions that when executed cause the at least one processor to one of:
generate a blurred version of the image and subtract the blurred version of the image from the image; or
convolve the image with different Gaussian kernels and determine a difference between resulting convolutions.
